(19) United States
(12) Patent Application Publication
(10) Pub. No.: US 2003/0222098 A1
(43) Pub. Date: Dec. 4, 2003

(54) Disposable cup dispenser with variable extraction force

(76) Inventors: Nga Thuy Luu, Appleton, WI (US); Joseph R. Pounder, Greenville, WI (US)

Correspondence Address: Michael W. Ferrell, Esq., Ferrells, PLLC, P.O. Box 312, Clifton, VA, 20124-1706, US

(21) Appl. No.: 10/405,393

(22) Filed: Apr. 2, 2003

Related U.S. Application Data
(60) Provisional application No. 60/384,734, filed on May 31, 2002.

(51) Int. Cl. B65H 3/30; B65G 59/00

(52) U.S. Cl. 221/307

(57) ABSTRACT

A cup dispenser for dispensing cups of differing size with variable extraction force includes: (a) a housing configured to receive a stack of disposable cups, the housing defining a housing opening as well as support means for receiving a dispensing ring member; (b) means for defining a dispensing aperture at the housing opening comprising at least one dispensing ring mounted on the housing support means therefor, the means for defining the dispensing aperture being generally configured to releasably retain the stack of disposable cups within said housing and require a predetermined extraction force to extract a cup from the stack in the housing, the required predetermined extraction force being variable depending upon the brim diameter of the cup. The dispenser may include 2 interchangeable rings, each of which is adapted for a specific size cup, or a single ring which requires an extraction force that varies with cup size.

### CLAIM FOR PRIORITY

This non-provisional application claims the benefit of the filing date of U.S. Provisional Patent Application Serial No. 60/384,734, of the same title, filed May 31, 2002.

### TECHNICAL FIELD

The present invention relates generally to canister-style cup dispensers and more particularly to a paper cup dispenser for at least 2 different size cups adapted to provide variable extraction force suited to particular cup sizes.

### BACKGROUND

Cup dispensers with dispensing apertures for dispensing cups are known in the art. Canister-style dispensers may be wall mounted or may have an associated stand for placing on a countertop, table or the like. See U.S. Pat. No. Des. 245,549 and U.S. Pat. No. Des. 316,199 to Brown, for examples.

Cup dispensers with apertures having variable dispensing aperture dimensions are likewise known. There is disclosed in U.S. Pat. No. 6,325,243 to Bennett a device for dispensing cups, pitchers, or other novelty items. The dispenser includes a dispensing aperture with rows of teeth as are shown in FIG. 5 of the '243 patent. The teeth may be made of polypropylene and the dispensing member is generally described in Col. 2 of the '243 patent as being about 6 inches in diameter and having an axial length of about one inch. There is provided upper and lower rows of teeth which project inwardly different distances. The dispensing member described in the '243 patent thus requires considerable space, making it less suited to environments where space is at a premium. Moreover, the axially spaced sets of teeth dictate a difficult to fabricate essentially 3 dimensional structure which may be manufactured in multiple steps or assembled from discrete parts. It is further noted that the '243 patent is directed to dispensers for plastic cups and the like where cup deformation and damage is largely a non-issue. See Col. 1, lines 5-7.

Another cup dispenser is shown in U.S. Pat. No. 5,709,316 to Jolly et al. In the '316 patent a dispensing aperture is defined by a membrane or film which is cut to adapt it to dispense cups of different sizes. This process is irreversible, since once the membrane is cut to accommodate a larger size cup, it is no longer suitable for smaller cups. So also, the film or membrane would need to be carefully tensioned to operate properly, with perhaps little margin for error.

Still yet other dispensers are disclosed in the following: U.S. Pat. No. 2,584,941 to Taubert; U.S. Pat. No. 3,581,934 to Sciascia; U.S. Pat. No. 3,623,636 to D'Ercoli et al.; U.S. Pat. No. 3,790,023 to Filipowicz; U.S. Pat. No. 3,844,444 to Carroll; U.S. Pat. No. 4,126,248 to House; U.S. Pat. No. 4,925,058 to Ozawa; U.S. Pat. No. 5,839,605 to Hadtke et al.; U.S. Pat. No. 5,884,803 to Vine; and U.S. Pat. No. 6,199,723 to Collins et al.

The present invention is generally directed to a paper cup dispenser adapted to dispense cups of different sizes with different extraction forces suited to different size paper cups. In this manner, the inventive dispenser provides for ease of dispensing, consistency of single cup dispensing, control of cup damage and simplified dispenser design.

### SUMMARY OF INVENTION

A cup dispenser for dispensing disposable cups of differing size with variable extraction force in accordance with the present invention includes a housing configured to receive a stack of disposable cups, the housing defining a housing opening as well as support means for receiving a dispensing ring member; a first and a second interchangeable dispensing rings, each of which rings is adapted to be selectively mounted on the support means of the dispenser housing at the housing opening to define a dispensing aperture, and each of which rings is configured to retain the stack of cups in the dispenser housing and require a predetermined extraction force to remove a cup from the stack. The first interchangeable dispensing ring includes a first support ring with a first plurality of equally spaced dispensing tabs anchored about their bases to an interior surface of the first support ring in substantially a single plane, wherein each of the first plurality of tabs projects inwardly a first predetermined distance and are thus configured to require a first predetermined extraction force to remove a cup of a first diameter from the stack of disposable cups retained in the housing thereby. A second interchangeable dispensing ring for dispensing cups of a different size includes a second support ring with a second plurality of equally spaced dispensing tabs anchored about their bases to an interior surface of the second support ring in substantially a single plane, wherein each of the second plurality of tabs projects inwardly a second predetermined distance and are thus configured to require a second predetermined extraction force to remove a cup of a second diameter from the stack of disposable cups retained in the housing thereby.

The cup dispenser is typically configured such that the first predetermined extraction force required to remove a cup of a first brim diameter from a stack of disposable cups retained in the housing differs from the second predetermined extraction force required to remove a cup of a second brim diameter from a stack of disposable cups retained in the housing of the dispenser. The dispenser is typically sized for cups having a brim diameter in the range of from about 65 mm to about 85 mm, such as paper cups provided with a curled brim. In one preferred embodiment, the first interchangeable dispensing ring is configured to require an extraction force of from about 0.8 lbs to about 1.4 lbs to remove a paper cup from the stack thereof retained in the housing when the paper cups have a brim diameter of about 70 mm. In such a case, the first plurality of dispensing tabs may define a dispensing diameter of about 66 mm. The second interchangeable dispensing ring may be configured to require an extraction force of from about 1.4 lbs to about 5 lbs to remove a paper cup from the stack thereof retained in the housing when the paper cups have a brim diameter of about 78 mm. To require this extraction force, the second plurality of dispensing tabs define a dispensing diameter of about 72 mm. Suitable extraction force ranges may respectively be from about 0.9 lbs to about 1.2 lbs for the smaller ring and from about 2 lbs to about 4 lbs for the larger ring if so desired.

The first and second interchangeable dispensing rings are advantageously integrally formed of a polymeric material and have their dispensing tabs angled downwardly with respect to the plane in which the bases of the tabs are anchored to their respective support rings at an angle of from about 5° to about 25°. Typically, the dispensing rings are injection molded from a polymeric material such as polyethylene polymers, for example, LDPE, HDPE, or a polypropylene polymer and include 4 to 8 dispensing tabs in some embodiments.

Polypropylene polymers which are suitable are preferably selected from the group consisting of isotactic polypropylene, and copolymers of propylene and ethylene wherein the ethylene moiety is less than about 10% of the units making up the polymer, and mixtures thereof. Generally, such polymers have a melt flow index from about 0.3 to about 4. A suitable polymer is isotactic polypropylene with a melt-flow index of about 1.5.

A polyethylene polymer for use in connection wit the invention may be any suitable polyethylene such as HDPE, LDPE, MDPE, LLDPE or mixtures thereof and may be melt-blended with polypropylene if so desired. The various polyethylene polymers referred to herein are described at length in the Encyclopedia of Polymer Science & Engineering (2d Ed.), Vol. 6; pp: 383-522, Wiley 1986; the disclosure of which is incorporated herein by reference. HDPE refers to high density polyethylene which is substantially linear and has a density of generally greater that 0.94 up to about 0.97 g/cc. LDPE refers to low density polyethylene which is characterized by relatively long chain branching and a density of about 0.912 g/cc to about 0.925 g/cc. LLDPE or linear low density polyethylene is characterized by short chain branching and a density of from about 0.92 g/cc to about 0.94 g/cc. Finally, intermediate density polyethylene (MDPE) is characterized by relatively low branching and a density of from about 0.925 g/cc to about 0.94 g/cc. The polymer materials may include mineral fillers such as talc, mica or glass.

The dispensing tabs are most preferably configured to each have a central portion projecting inwardly to define the dispensing diameter of their respective dispensing rings and lateral passive portions adjacent their central portions which project inwardly a lesser distance than their central portions. In some configurations, the central portions of the tabs of at least one of the dispensing rings extend around at least 180° of the periphery of the dispensing aperture of the dispenser, while the central portions of the tabs of the other dispensing ring extend around less than 180° of the periphery of the dispensing aperture of the dispenser. The central portions of the tabs may have rounded corners at the edges of their central portions defining the dispensing diameters of their respective dispensing rings. Typically, the first plurality of tabs and the second plurality of tabs have a thickness of from about 0.5 mm to about 1 mm. So also, the first and second dispensing rings are provided with indicia indicating a cup size the respective ring is adapted to dispense.

In another aspect of the present invention, a dual-purpose dispensing ring configured to require different extraction forces for different size cups is fitted to the dispenser. There is thus provided a cup dispenser for dispensing disposable cups of differing size with variable extraction force including a housing configured to receive a stack of disposable cups, the housing defining a housing opening as well as support means for receiving a dispensing ring, a variable extraction force dispensing ring mounted at the housing opening configured to retain the stack of cups in the dispenser housing and require a predetermined extraction force to remove a cup from the stack, the variable extraction force dispensing ring comprising a support ring with a first and second plurality of equally spaced dispensing tabs anchored about their bases to an interior surface of the support ring in substantially a single plane, wherein each of the first plurality of tabs projects inwardly a first predetermined distance and each of the second plurality of tabs projects inwardly a second predetermined distance.

The first plurality of dispensing tabs and said second plurality of dispensing tabs of the dual purpose dispensing ring are thus configured to require a first predetermined extraction force to remove a cup of a first brim diameter from a stack retained in the housing and to require a second predetermined extraction force to remove a cup of a second brim diameter from a stack retained in the housing. Here again, the first predetermined extraction force required to remove a cup of a first brim diameter from a stack of disposable cups retained in the housing differs from the second predetermined extraction force required to remove a cup of a second brim diameter from a stack of disposable cups retained in the housing of the dispenser. The cup dispenser is adapted to dispense disposable cups of differing size having a brim diameter in the range of from about 65 mm to about 85 mm. This embodiment is likewise suitable to dispense a stack of paper cups provided with a curled brim, requiring the same extraction forces noted above, that is to say, the first plurality of tabs of the dispensing ring are generally configured to require an extraction force of from about 0.8 lbs to about 1.4 lbs to remove a paper cup from the stack thereof retained in the housing when the cups have a brim diameter of about 70 mm and may define a first dispensing diameter of about 66 mm, whereas the dispensing ring is configured to require an extraction force of from about 1.4 lbs to about 5 lbs to remove a paper cup from the stack thereof retained in the housing when the cups have a brim diameter of about 78 mm. The second plurality of dispensing tabs may define another dispensing diameter of about 72 mm. The first and second plurality of dispensing tabs may include 4 tabs each and generally have the features noted above. The combination dispensing ring is likewise injection molded in preferred embodiments from polyethylene or polypropylene.

There is thus generally provided a cup dispenser for dispensing cups of differing size with variable extraction force including a housing configured to receive a stack of disposable cups, the housing defining a housing opening as well as support means for receiving a dispensing ring member; means for defining a dispensing aperture at the housing opening comprising at least one dispensing ring mounted on the housing support means therefor, the means for defining the dispensing aperture being generally configured to releasably retain the stack of disposable cups within said housing and require a predetermined extraction force to extract a cup from the stack in the housing, the required predetermined extraction force being variable depending upon the brim diameter of the cup, wherein the means for defining the dispensing aperture is selected from the group consisting of: a first and a second interchangeable dispensing rings, each of which rings is adapted to be selectively mounted on the support means of the dispenser housing to define a dispensing aperture, and each of which rings is configured to retain the stack of cups in the dispenser housing and require a predetermined extraction force to remove a cup from the stack, the first interchangeable dispensing ring comprising a first support ring with a first plurality of equally spaced dispensing tabs anchored about their bases to an interior surface of the first support ring in substantially a single plane, wherein each of the first plurality of tabs projects inwardly a first predetermined distance and are thus configured to require a first predetermined extraction force to remove a cup of a first diameter from the stack of disposable cups retained in the housing thereby, the second interchangeable dispensing ring comprising a second support ring with a second plurality of equally spaced dispensing tabs anchored about their bases to an interior surface of the second support ring in substantially a single plane, wherein each of the second plurality of tabs projects inwardly a second predetermined distance and are thus configured to require a second predetermined extraction force to remove a cup of a second diameter from the stack of disposable cups retained in the housing thereby; as well as a dual-purpose variable extraction force dispensing ring configured to retain the stack of cups in the dispenser housing and require a predetermined extraction force to remove a cup from the stack. The variable extraction force dispensing ring comprises a third support ring with a third and fourth plurality of equally spaced dispensing tabs anchored about their bases to an interior surface of the third support ring in substantially a single plane, wherein each of the third plurality of tabs projects inwardly a third predetermined distance, each of the fourth plurality of tabs projects inwardly a fourth predetermined distance, the third plurality of dispensing tabs and said fourth plurality of dispensing tabs being thus configured to require a first predetermined extraction force to remove a cup of a first brim diameter from a stack retained in the housing and to require a second predetermined extraction force to remove a cup of a second brim diameter from a stack retained in the housing.

### BRIEF DESCRIPTION OF DRAWINGS

The invention is described in detail below in connection with the drawings wherein like numbers designate similar parts and wherein:

FIG. 1 is a view in elevation of a cup dispenser constructed in accordance with the present invention housing a stack of disposable cups;

FIG. 2 is a view in section and elevation of the cup dispenser and cups of FIG. 1 along line 2-2;

FIG. 3 is an exploded view showing the stack of paper cups and the cup dispenser of FIG. 1 showing the various parts thereof;

FIG. 4 is a top view of the dispenser of FIG. 1;

FIG. 5 is a detail generally along line 5-5 of FIG. 4 illustrating operation of the inventive cup dispenser and in particular the operation of a dispensing ring retaining a stack of paper cups;

FIGS. 6A-6I are views in perspective of various dispensing ring designs which were tested in a dispenser of a general class shown in FIGS. 1 through 5;

FIG. 7 is a bar graph illustrating the extraction force required to remove a 7 ounce cup from the dispenser of FIG. 1 fitted with a dispensing ring of the various designs shown in FIGS. 6A-6I made from polypropylene;

FIG. 8 is a bar graph illustrating the extraction force required to remove a 7 ounce cup from the dispenser of FIG. 1 fitted with a dispensing ring of the various designs shown in FIGS. 6A-61 made from LDPE or HDPE;

FIG. 9 is a bar graph illustrating the extraction force required to remove a 9 ounce cup from the dispenser of FIG. 1 fitted with a dispensing ring of the type shown in FIGS. 6A-6I made from polypropylene;

FIG. 10 is a bar graph illustrating the extraction force required to remove a 9 ounce cup from the dispenser of FIG. 1 fitted with a dispensing ring of the type shown in FIGS. 6A-6I made from LDPE or HDPE;

FIG. 11 is a view in perspective of a dispensing ring for the dispenser of FIG. 1 particularly adapted to dispense 7 ounce cups;

FIG. 12 is a plan view of the dispensing ring of FIG. 11;

FIG. 13 is a view in elevation of the dispensing ring of FIGS. 11 and 12;

FIG. 14 is a detail of the dispensing ring of FIGS. 11 through 13 along line 14-14 of FIG. 12;

FIG. 15 is a view in perspective of a dispensing ring for use in connection with the dispenser of FIG. 1 and following particularly adapted to dispense 9 ounce cups;

FIG. 16 is a plan view of the dispensing ring of FIG. 15;

FIG. 17 is a view in elevation of the dispensing ring of FIGS. 15 and 16;

FIG. 18 is a detail of the dispensing ring of FIGS. 15 through 17 along line 18-18 of FIG. 16;

FIG. 19 is a view in perspective of a dual-purpose 7 and 9 ounce cup dispensing ring for use in connection with the dispenser of FIG. 1 adapted to dispense both 7 and 9 ounce paper cups;

FIG. 20 is a plan view of the dispensing ring of FIG. 19;

FIG. 21 is a view in elevation of the dispensing ring of FIGS. 19 and 20; and

FIG. 22 is a detail of the dispensing ring of FIGS. 19 through 21 along lines 22-22 of FIG. 20.

### DETAILED DESCRIPTION

The invention is described in detail below for purposes of exemplification and illustration only. Modifications to the various embodiments shown within the spirit and scope of the present invention, set forth in the appended claims, will be readily apparent to those of skill in the art.

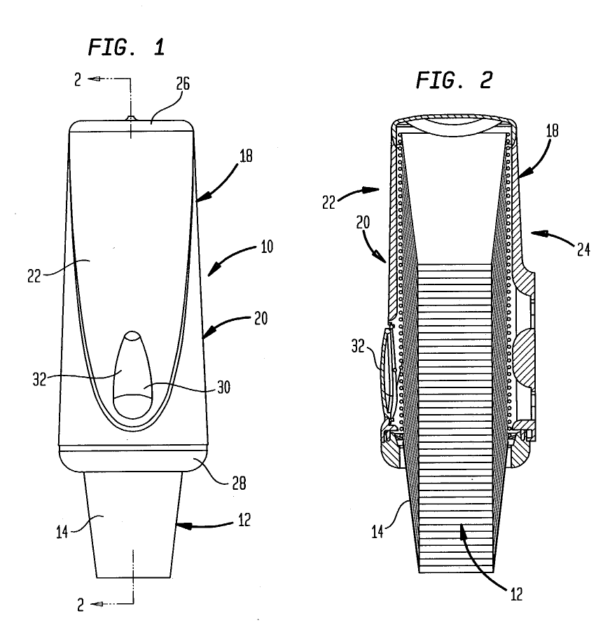

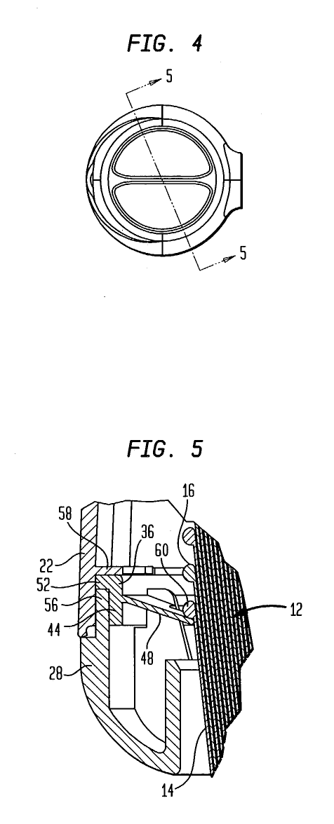

Referring generally to FIGS. 1 through 5 there is shown a paper cup dispenser 10 for receiving a stack 12 of paper cups such as cups 14, 16 and so forth. Each cup is generally frustoconical in shape and has at its upper portion a rolled brim having an outer diameter D_{b} which is useful for reinforcing the cup structure and also is utilized in connection with the dispensing rings of the present invention as will become apparent from the discussion which follows. The dispenser of FIGS. 1 through 5 is particularly suited for receiving stacks of 7 ounce and 9 ounce cups as are well known in the art and of standard sizes.

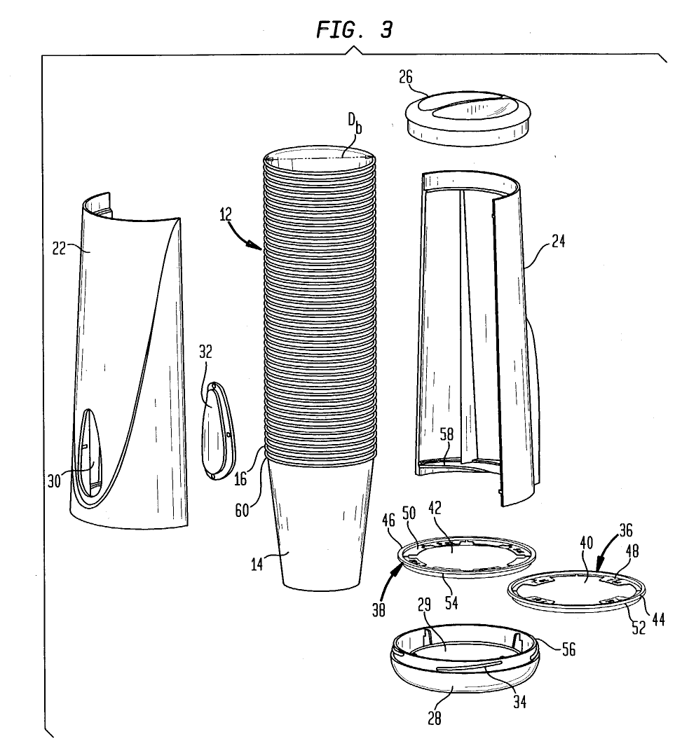

Dispenser 10 includes a housing 18 having generally a canister 20 made up of a first semi-cylindrical member 22 and a second semi-cylindrical member 24. The housing also has a top 26 which may be friction fit or a screw top as well as a bottom 28 provided with an opening 29 as well as threads 34 as shown particularly in FIG. 3.

Dispenser member 22 is further provided with a sight port 30 adapted to retain a sight window 32 so that the presence of cups in the dispenser may be monitored.

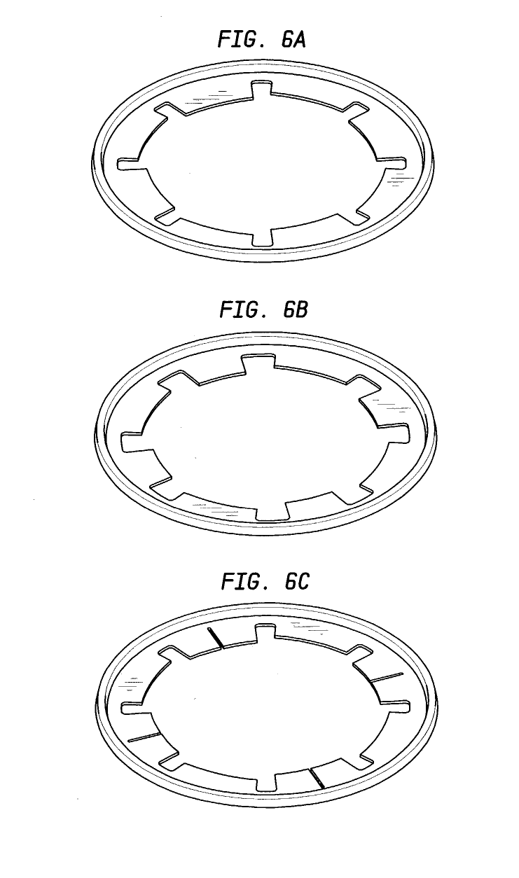

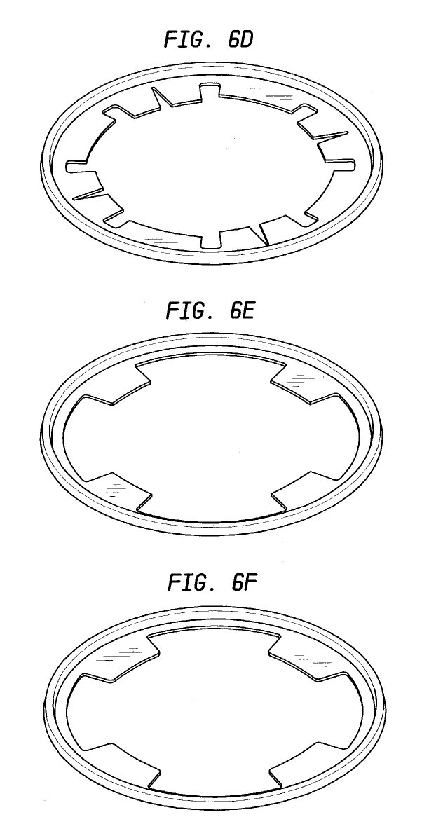

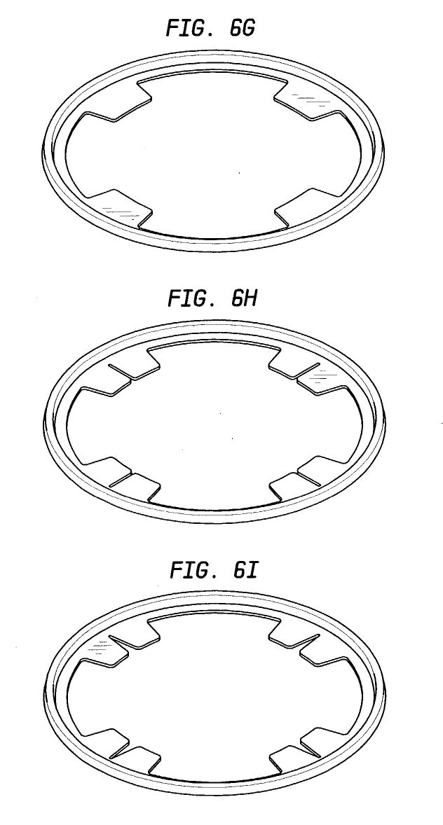

In one embodiment the dispenser is preferably provided with a pair of interchangeable rings 36 and 38 which are to be used alternately depending on the cup size desired to be dispensed. In other words, ring 36 may be particularly adapted and dimensioned to dispense 7 ounce cups while dispensing ring 38 may be particularly adapted to dispense 9 ounce cups as further described in the discussion which follows hereinafter. Generally speaking, the dispensing rings include a dispensing opening such as openings 40 and 42, a support ring such as rings 44 and 46 as well as a plurality of dispensing tabs such as tabs 48 and 50 shown particularly in FIGS. 3 and 5. It should be noted that the dispensing ring includes a shoulder such as shoulders 52 and 54 on the support ring which are adapted to rest on a lip 56 as well as engage a shelf 58 in the dispenser when the bottom 28 is screwed into canister member 20 to retain the ring. The cups may be added from the top; that is to say, top 26 is removed and the cups put in the dispenser which are retained by a dispensing ring which is ring 36 or 38 by way of a dispensing tabs such as tab 48 or tab 50. The actual operation of the dispenser is better appreciated by reference to FIG. 5 wherein it can be seen that a dispensing ring such as interchangeable dispensing ring 36 is mounted between shelf 58 and lip 56 of the housing such that the plurality of dispensing tabs such as tab 48 securely engage a curled rim 60 of a cup in stack 12 as shown in the diagram. That is to say, the dispensing tabs frictionally engage the brims of the cups, such as brim 60 and retains the stack 12 inside the dispenser. When it is desired to remove a cup the lower most cup such as cup 14, is grasped by a user and drawn through the dispensing aperture that is opening 40 of ring 36 by virtue of an extraction force applied by a user.

It has been found in accordance with the present invention that it is critical to configure the dispensing tabs such that the amount of extraction force required to remove the cups is not too large or too small such that single cup dispensing without damage to the cup may be achieved. This force will vary depending upon the size of the cup being dispensed as well as the geometry and the material from which a dispensing ring such as dispensing rings 36 and 38 are fabricated. Most preferably, dispensing rings such as rings 36 and 38, are integrally formed by way of injection molding such that the dispensing tabs and the support rings are of the same material. To this end, the base of the tabs is generally anchored in a single plane about the inner surface of the support ring as described in more detail in connection with specific dispensing rings.

In order to test various designs, a number of dispensing rings having the geometry shown in FIGS. 6A through 6I were fabricated from polypropylene, HDPE, and LDPE. The various designs for combination 7/9 ounce dispensing rings were dimensioned for use with 7 and 9 ounce cups having generally the brim dimensions shown in Table 1.

TABLE 1
Typical Cup Dimensions

| Capacity Fluid Ounces | Brim Diameter inches/mm |
|---|---|
| 7 | 2.75 ± 0.05/70 ± 1 |
| 9 | 3.08 ± 0.05/78 ± 1 |

These dispensing ring designs made from various materials were tested for single cup dispensability, degree of cup damage, and ease of dispensability in connection with 7 and 9 ounce paper cups. Results appear in Table 2.

TABLE 2
Comparative Performance Data
9 oz Cup Dispenser Lip Designs

| | | Single-Cup | | | | | |
|---|---|---|---|---|---|---|---|
| Dispensing Ring | | Dispensability % | | Degree of Cup Damage | | Ease of Dispensability | |
| Material | Tab Design | 7 oz cups | 9 oz cups | 7 oz cups | 9 oz cups | 7 oz cups | 9 oz cups |
| PP | 6A | * | * | * | * | * | * |
| PP | 6B | 38 | 100 | None | Slight | Easy | Med/Hard |
| PP | 6C | 98 | 98 | None | None/Slight | Very Easy | Hard |
| PP | 6D | 98 | 95 | None | Slight | Easy | Hard |
| PP | 6E | 98 | 95 | None | Slight | Easy | Medium |
| PP | 6F | 91 | 93 | None | Slight | Easy | Medium |
| PP | 6G | 94 | 91 | None | None/Slight | Easy | Medium |
| PP | 6H | 96 | 91 | None | Slight | Easy | Easy/Med |
| PP | 6I | 91 | 91 | None | Slight | Easy | Easy/Med |
| HDPE | 6A | 95 | 93 | None | Significant | Very Easy | Very Hard |
| HDPE | 6B | 88 | 95 | None | Significant | Easy | Hard |
| HDPE | 6C | 92 | 98 | None | Slight | Easy | Hard |
| HDPE | 6D | 98 | 95 | None | Slight | Easy | Hard |
| HDPE | 6E | 98 | 98 | None | Slight | Easy/Med | Medium |
| LDPE | 6A | 1 | 65 | None | None | Very Easy | Easy |
| LDPE | 6B | 0 | 83 | None | None | Very Easy | Easy |
| LDPE | 6C | 0 | 72 | None | None | Very Easy | Easy |
| LDPE | 6D | 0 | 95 | None | None | Easy | Easy |
| LDPE | 6E | 0 | 8 | None | None | Very Easy | Easy |
| LDPE + 5% Talc | 6A | 8 | 88 | None | None | Easy | Easy |
| LDPE + 10% Talc | 6A | 4 | 88 | None | None | Easy | Easy |
| LDPE + 15% Talc | 6A | 2 | 87 | None | None | Easy | Easy |

*Design 6Anon-functional in polypropylene

It will be appreciated from Table 2 that the dispensing ring design as well as the material from which the dispensing ring is made greatly impacts performance of the dispenser. In order to more quantitatively characterize dispensing ring performance, an extraction force test was developed. The purpose of extraction force testing is to measure the force required to remove a cup from the dispenser. Combinations of different cup sizes and different dispensing rings exhibit different extraction forces. The equipment for the test consists of: 1) the dispenser(s), dispensing ring(s), and cup(s) of the size to be evaluated; 2) a hand-held force gauge capable of measuring and displaying the peak force encountered during dispensing; and 3) a lightweight metal hook, designed to pierce diametrically opposite side walls of the cup near the cup bottom, to attach the force gauge to the cup so that the cup/hook/gauge assembly can be pulled and so the force gauge can record the peak force encountered during extraction. The hook is attached to a sample cup and the cup is placed in the dispenser. The force gauge is attached to the hook and the cup/hook/gauge assembly is pulled manually to remove the cup from the dispenser and measure the peak force required to remove the cup. The rate at which the assembly is pulled mimics the rate at which a consumer would remove the cup from the dispenser. The rate is thus generally from about 3-12 inches per second and typically about 4-8 inches per second. The rate at which the assembly is pulled within this range is not believed critical. The process is repeated several times and an average force is determined for the particular cup size and dispensing ring combination being evaluated.

Results for 7 and 9 ounce cups using the dispensing rings of FIGS. 6A-6I made from various materials appear in Table 3.

TABLE 3
Extraction Force Data

| | Force 7 oz Cup | Force 9 oz Cup | Tab |
|---|---|---|---|
| Material | lbs | lbs | Design |
| LDPE | 0.67 | 1.80 | 6A |
| LDPE | 0.37 | 1.38 | 6D |
| LDPE | 0.48 | 1.31 | 6E |
| HDPE | 1.92 | 6.77 | 6A |
| HDPE | 1.37 | 5.25 | 6D |
| HDPE | 1.18 | 3.91 | 6E |
| PP | 1.49 | 5.42 | 6A |
| PP | 1.15 | 3.96 | 6E |
| PP | 0.84 | 3.76 | 6G |
| PP | 0.91 | 3.44 | 6H |
| PP | 1.17 | 3.62 | 6I |

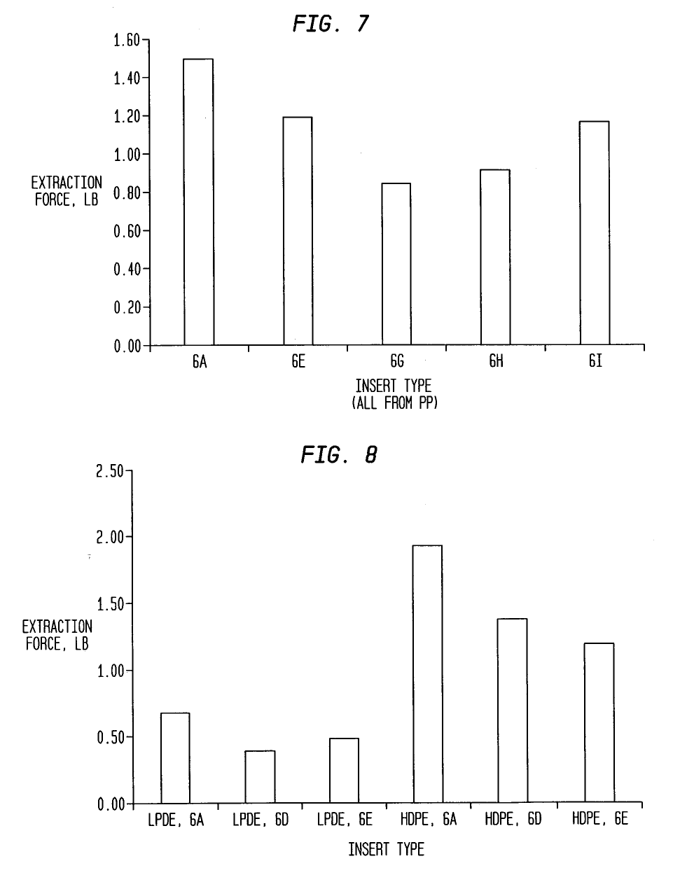

The extraction force data observed for the various designs and materials is also set forth in FIGS. 7 through 10.

FIG. 7 is a bar graph of the extraction force to remove a 7 ounce cup for various designs all made from polypropylene.

FIG. 8 is a bar graph of the extraction force for various designs of FIGS. 6A through 6I made from either HDPE or LDPE for 7 ounce cups.

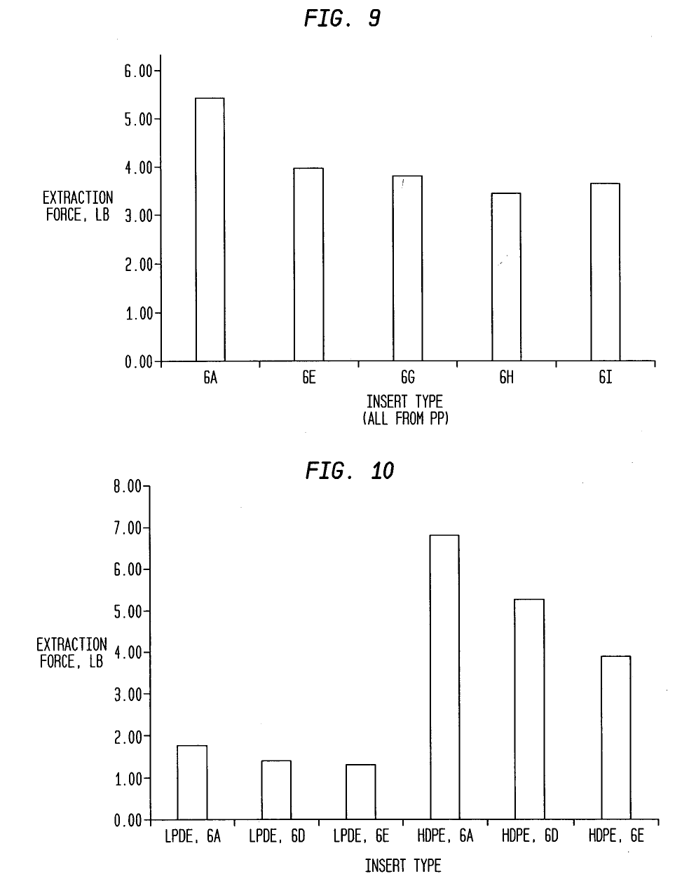

FIG. 9 is a bar graph showing the extraction force observed for 9 ounce cups of various designs all made from polypropylene.

FIG. 10 is a bar graph of the extraction force for various designs of FIGS. 6A through 6I made from either HDPE or LDPE for 9 ounce cups.

Based on the test data, both qualitative and quantitative, it was found that for 7 ounce cups the extraction force was preferably from about 0.8 lbs to about 1.4 lbs having a maximum of about 1.5 lbs and a minimum amount of about 0.7 lbs. For 9 ounce cups, the preferred extraction force was from about 1.4 lbs to about 4 lbs having a maximum of about 5.25 lbs and a minimum of about 1.3 lbs. This data is summarized in Table 4.

TABLE 4
Preferred Extraction Forces

| Cup | | | Extraction Force |
|---|---|---|---|
| Volume | Rim Diameter | Extraction Force | Maximum/(Min) |
| (ounces) | (inches/mm) | Range (lbs) | (lbs) |
| 7 | 2.75 ± 0.05/70 ± 1 | 0.8-1.4 | 1.5 (0.7) |
| 9 | 3.08 ± 0.05/78 ± 1 | 1.4-4 | 5.25 (1.3) |

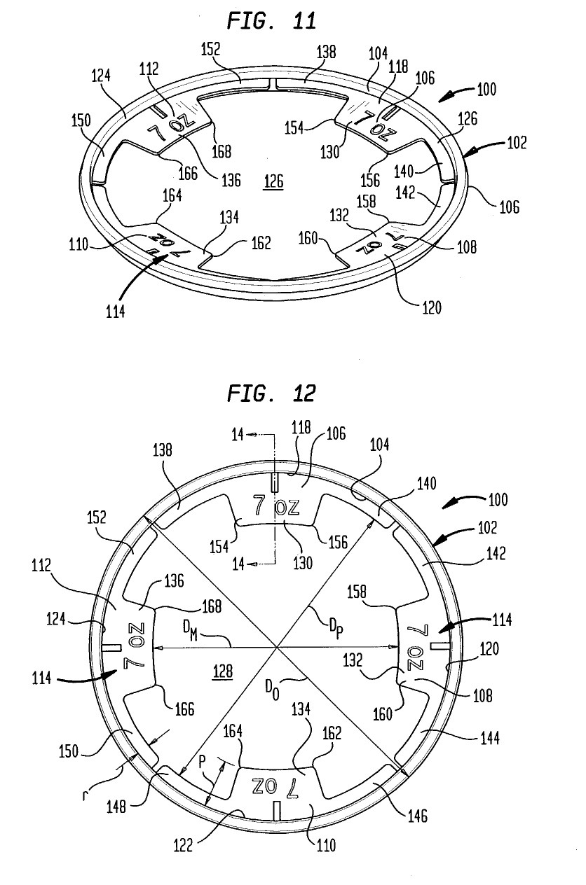

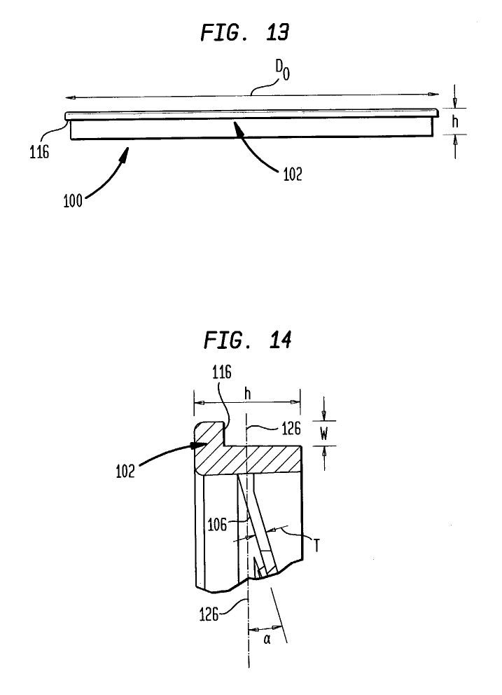

Based on the above findings, a dispensing ring design for a 7 ounce cup was arrived at as shown and described in connection with FIGS. 11 through 14. The particular dispensing ring was injection molded from polypropylene (Profax 857) available from Basell North America, Inc. of Wilmington, Del.

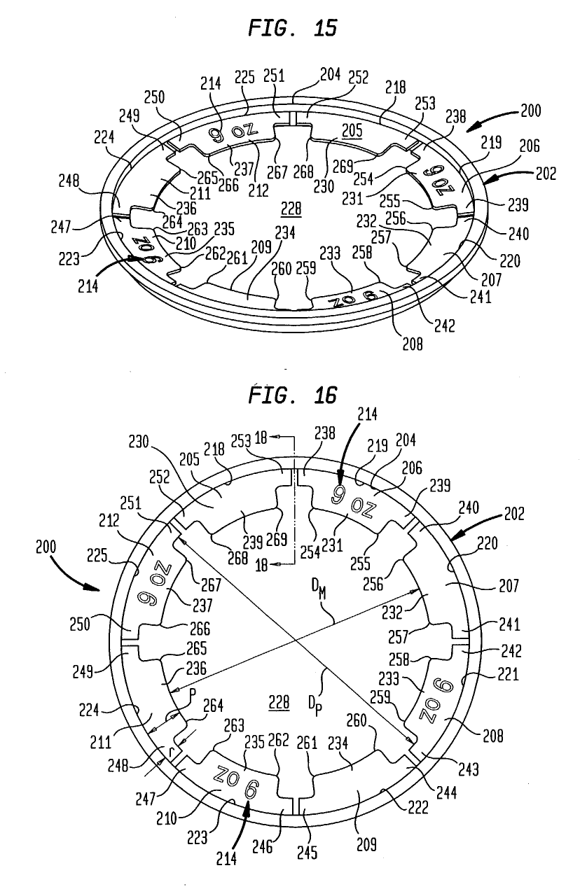

There is shown in FIGS. 11 through 14 a dispensing ring 100 including a support ring 102 with an inner surface 104 supporting a plurality of tabs 106, 108, 110, and 112. The tabs are further provided with indicia 114 indicating that the ring is suited for dispensing a 7 ounce cup. The support ring further includes a shoulder 116 adapted to be mounted on lip 56 of the bottom of dispenser 10 shown in FIGS. 1 and following such that it can be secured between lip 56 and lip 58. Note that dispensing ring 100 is an interchangeable dispensing ring which can be alternately disposed in the dispenser of FIGS. 1 and following with a different size dispensing ring such as that shown in FIGS. 15 and following when it is desired to dispense a different size cup as will be readily appreciated from the discussion which follows.

Each of the four dispensing tabs 106-112, projects inwardly from support ring 102 in order to engage the brim, such as brim 60 of a cup to be dispensed from dispenser 10. The dispensing ring has the various dimensions shown in the diagram and summarized in Table 5 below. The support ring 102 has a ring height, h, of about 6.5 mm, for example. The aperture diameter, Dₘ, is about 66 mm for a 7 ounce cup having a brim diameter of about 70 mm. Note that the aperture diameter is the distance between the central position of opposed dispensing tabs, as is shown in the diagram.

It should be noted from FIGS. 11 through 14 that each of the dispensing tabs 106-112 is anchored at its base 118 through 124 in a single plane 126 as shown. This feature makes it possible to fabricate the dispensing ring in a single injection molding operation by utilizing conventional equipment. Most preferably, each of the projections is angled downwardly with respect to plane 126 over an angle α of about 5 to about 25°.

As shown the dispensing rings are characterized by a dispensing diameter Dₘ a projection thickness, T, a passive projection diameter Dₚ and overall diameter Dₒ, a projection distance P from inner surface 104 of the dispensing ring towards the inner opening 128 of the dispensing ring and a passive projection distance r. Moreover, the retaining shoulder has a retaining shoulder width w as shown in the diagram. For the particular cup employed, that is a cup with a 70 mm brim the dispensing ring of FIGS. 11 through 14 may be made of polypropylene with the dimensions shown in Table 5. It should be noted that the dispensing diameter Dₘ is defined by the distance between opposed tabs such as tabs 106 and 110 as well as opposed tabs 108 and 112 as shown in the diagram. The tabs generally have central portions 130 to 136 as well as lateral portions 138 through 152. The lateral portions are generally passive although they will contribute to the overall rigidity of the ring. The total maximum inward projection from surface 104 of the central portion of the dispensing ring may be for example about 13 mm.

As will be appreciated by one of the skill in the art the thickness of the tabs will directly affect the required extraction force but is generally from about 0.5 to about 1 mm in thickness.

The central portion of each tab has rounded corners 154-168 at its outer edges which has been found to facilitate dispensing of the cups.

TABLE 5
Dimensions 7 oz Dispenser Ring Insert (mm)

| | |
|---|---|
| Ring Height, h | 6.5 |
| Dispensing Aperture diameter, Dₘ | 66 |
| Projection Thickness, T | 0.75 |
| Passive Projection diameter, Dₚ | 85 |
| Overall Diameter, D₀ | 98 |
| Projection Distance, P | 13 |
| Passive ring Projection, r | 3 |
| Retaining Shoulder Width, w | 1.5 |

Material: Polypropylene, Basell North America, Inc. Profax 857

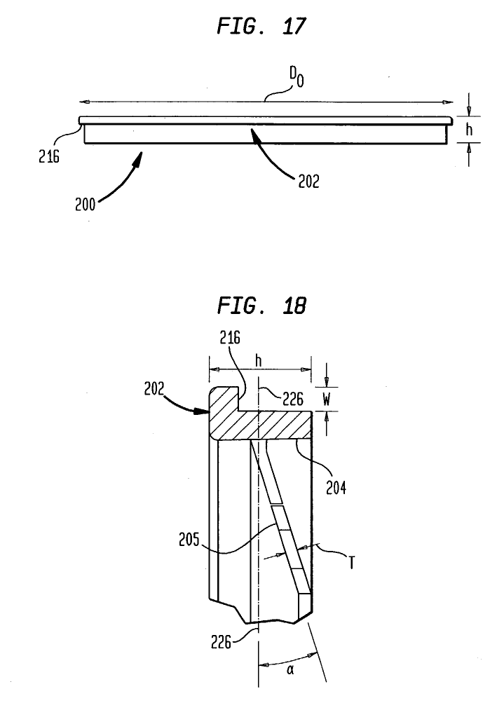

There is shown in FIGS. 15 through 18 another dispensing ring which may be used in the dispenser of FIGS. 1 and following instead of the dispensing ring of FIGS. 11 through 14 when it is desired to dispense 9 ounce cups instead of 7 ounce cups, the various parts of the dispensing ring of FIGS. 15 through 18 are numbered 100 numerals higher than corresponding parts in the dispensing ring of FIGS. 11 through 15.

There is shown in FIGS. 15 through 18 a dispensing ring 200 including a support ring 202 with an inner surface 204 supporting a plurality of tabs 205-212. The tabs are further provided with indicia 214 indicating that the ring is suited for dispensing a 9 ounce cup. The support ring further includes a shoulder 216 adapted to be mounted on lip 56 of the bottom of dispenser 10 shown in FIGS. 1 and following such that it can be secured between lip 56 and lip 58.

Each of the dispensing tabs 205-212, projects inwardly from support ring 202 in order to engage the brim, such as brim 60 of a cup to be dispensed from dispenser 10. The dispensing ring has the various dimensions shown in the diagram and summarized in Table 6 below. The support ring 202 has a ring height, h, of about 6.5 mm, for example. The dispensing aperture diameter, Dₘ, is about 72 mm for a 9 ounce cup having a brim diameter of about 78 mm.

It can be seen in FIGS. 15 through 18 that each of the dispensing tabs 205-212 is anchored at its base 218 through 225 in a single plane 226 as shown. This feature makes it possible to fabricate the dispensing ring in a single injection molding operation by utilizing conventional equipment. Most preferably, each of the projections is angled downwardly with respect to plane 216 over an angle α of about 5 to about 25°. As shown, the dispensing rings are further characterized by a dispensing tab thickness, T, a passive projection diameter Dₚ and overall diameter Dₒ, a projection distance P from inner surface 204 of the dispensing ring towards the inner opening 228 of the dispensing ring. A passive projection, r, from inner surface 204 is about 4 mm. Moreover, the retaining shoulder has a retaining shoulder width w as shown in the diagram. For the particular cup employed, that is, a 9 ounce cup with a 78 mm brim the dispensing ring of FIGS. 15 through 18 may be made of LDPE with the dimensions shown in Table 6. It should be noted that the dispensing diameter Dₘ is defined by the distance between opposed tabs such as tabs 205 and 209 as well as opposed tabs 207 and 211 and so forth as shown. The tabs generally have central portions 230 to 237 as well as lateral portions 238 through 253. The lateral portions are generally passive although they will contribute to the overall rigidity of the ring, and may have a passive diameter, Dₚ of 83 mm or so. The maximum total inward projection from surface 204 of the central portion of the dispensing tabs may be, for example, about 13 mm.

As will be appreciated by one of the skill in the art the thickness of the tabs will directly affect the required extraction force but is generally from about 0.5 to about 1 mm in thickness for the ring shown in FIGS. 15 through 18.

The central portion of each tab has rounded corners 254-269 at its outer edges which has been found to facilitate dispensing of the cups.

TABLE 6
Dimensions for 9 oz Dispenser Ring Insert (mm)

| | |
|---|---|
| Ring Height, h | 6.5 |
| Dispensing Diameter, Dₘ | 72 |
| Projection Thickness, T | 0.75 |
| Passive Projection Diameter, Dₚ | 83 |
| Overall Diameter, Dₒ | 98 |
| Projection Distance, P | 10 |
| Passive Ring Projection, r | 4 |
| Retaining Shoulder Width, w | 1.5 |

Material: LDPE, Eastman Chemical Company, Kingsport, Tennessee, Tenite 800A

It should be noted that the central portions of the tabs of the dispensing ring of FIGS. 15 through 18 extend around more than half, that is more than 180° of the periphery of the dispensing ring in order to engage the cups, whereas the dispensing tabs in the dispensing ring shown in FIGS. 11 through 14 extend around less than half of the inner periphery of the dispensing ring, that is less than 180° in the earlier embodiment.

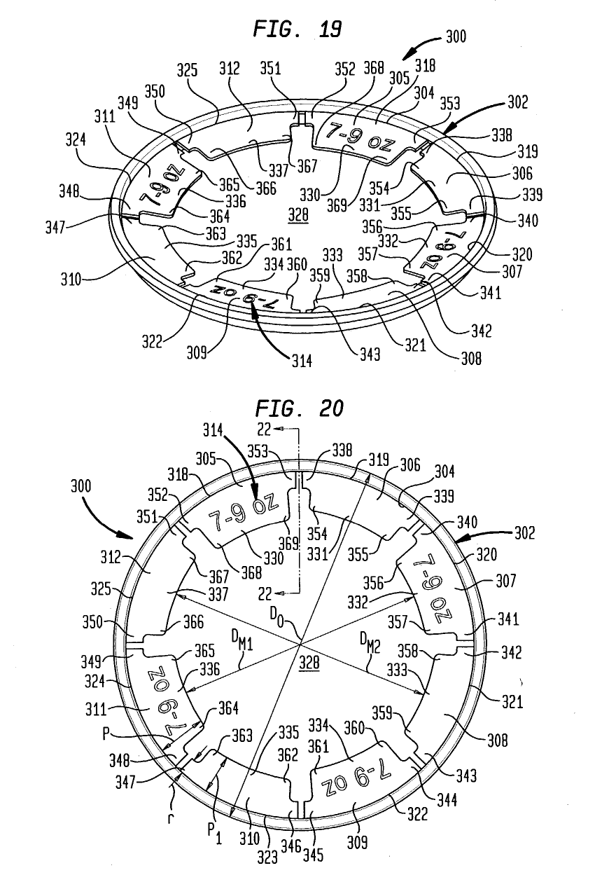

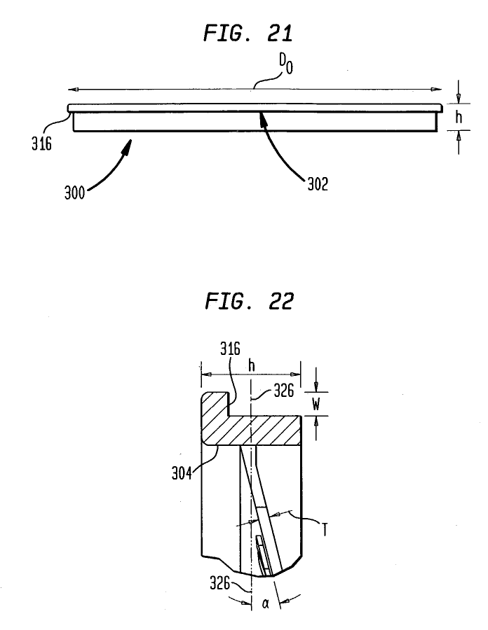

Still yet another dispensing ring, a so-called combination or dual-purpose ring, which may be used to dispense both 7 and 9 ounce cups is shown in FIGS. 19 through 22. Here the corresponding parts, where applicable, are numbered 100 numerals higher than corresponding parts in the embodiment of FIGS. 15 through 18. Here however, since it is a combination dispensing ring, there are two sets of 4 equally spaced dispensing tabs defining 2 dispensing aperture diameters.

There is shown in FIGS. 19 through 22 a dispensing ring 300 including a support ring 302 with an inner surface 304 supporting a plurality of tabs 305-312. The tabs are further provided with indicia 314 indicating that the ring is suited for dispensing either a 7 or a 9 ounce cup. The support ring further includes a shoulder 316 adapted to be mounted on lip 56 of the bottom of dispenser 10 shown in FIGS. 1 and following such that it can be secured between lip 56 and lip 58. Note that dispensing ring 300 is a dual-purpose dispensing ring which can be disposed in the dispenser of FIGS. 1 and following when it is desired to dispense either 7 or 9 ounce cups.

Each of the dispensing tabs 305-312, projects inwardly from support ring 302 in order to engage the brim, such as brim 60 of a cup to be dispensed from dispenser 10. The dispensing ring has the various dimensions shown and summarized in Table 7 below. The support ring 302 has a ring height, h, of about 6.5 mm, for example. A first aperture diameter, Dₘ₁, is about 66 mm and a second dispensing diameter, Dₘ₂ is about 72 mm.

It should be noted from FIGS. 19 through 22 that each of the dispensing tabs 305-312 is anchored at its base 318 through 325 in a single plane 326 as shown in the diagrams. This feature makes it possible to fabricate the dispensing ring in a single injection molding operation by utilizing conventional equipment. Most preferably, each of the projections is angled downwardly with respect to inner surface 304 over an angle α of about 5 to about 25°.

As shown the dispensing rings are characterized by a first and second dispensing diameter Dₘ₁ and Dₘ₂, respectively, a projection thickness, T, a passive projection distance, r, and overall diameter Dₒ, a maximum projection distance P from an inner portion of the dispensing tab towards the inner opening 328 of the dispensing ring and a medium projection distance P₁. Moreover, the retaining shoulder has a retaining shoulder width w as shown. The dispensing ring of FIGS. 19 through 22 may be made of HDPE with the dimensions shown in Table 7. It should be noted that the dispensing diameters Dₘ₁ and Dₘ₂ are defined by the distance between opposed tabs such as tabs 305 and 309 (or 307 and 311) as well as opposed tabs 308 and 312 as shown. The tabs generally have central portions 330 to 337 as well as lateral portions 338 through 353. The lateral portions are generally passive although they will contribute to the overall rigidity of the ring. The maximum inward projection from surface 304 of the central portion of the dispensing ring may be for example about 13 mm.

As will be appreciated by one of the skill in the art the thickness of the tabs will directly affect the required extraction force but is generally from about 0.5 to about 1 mm in thickness.

The central portion of each tab has rounded corners 354-369 at its outer edges which has been found to facilitate dispensing of the cups.

TABLE 7
Dimensions 7-9 oz Combination Dispenser Ring Insert (mm)

| | |
|---|---|
| Ring Height, h | 6.5 |
| First Dispensing Aperture | 66 |
| Diameter, Dₘ₁ | |
| Second Dispensing Aperture | 72 |
| Diameter, Dₘ₂ | |
| Projection Thickness, T | 0.75 |
| Overall Diameter, Dₒ | 98 |
| Max Projection Distance, P | 13 |
| Med Projection Distance, P₁ | 10 |
| Passive Projection distance, r | 4 |

Material: HDPE, Dow Chemical Company, Midland, Michigan, 10462N

While the invention has been described in detail in connection with various embodiments, modifications within the spirit and scope of the present invention, set forth in the appended claims will be readily apparent to those of skill in the art.

What is claimed is:

1. A cup dispenser for dispensing disposable cups of differing size with variable extraction force comprising:
(a) a housing configured to receive a stack of disposable cups, the housing defining a housing opening as well as support means for receiving a dispensing ring member;
(b) a first and a second interchangeable dispensing rings, each of which rings is adapted to be selectively mounted on the support means of the dispenser housing at the housing opening to define a dispensing aperture, and each of which rings is configured to retain the stack of cups in the dispenser housing and require a predetermined extraction force to remove a cup from the stack,
(i) said first interchangeable dispensing ring comprising a first support ring with a first plurality of equally spaced dispensing tabs anchored about their bases to an interior surface of the first support ring in substantially a single plane, wherein each of the first plurality of tabs projects inwardly a first predetermined distance and are thus configured to require a first predetermined extraction force to remove a cup of a first diameter from the stack of disposable cups retained in the housing thereby,
(ii) said second interchangeable dispensing ring comprising a second support ring with a second plurality of equally spaced dispensing tabs anchored about their bases to an interior surface of the second support ring in substantially a single plane, wherein each of the second plurality of tabs projects inwardly a second predetermined distance and are thus configured to require a second predetermined extraction force to remove a cup of a second diameter from the stack of disposable cups retained in the housing thereby.

2. The cup dispenser according to claim 1, wherein the first predetermined extraction force required to remove a cup of a first brim diameter from a stack of disposable cups retained in the housing differs from the second predetermined extraction force required to remove a cup of a second brim diameter from a stack of disposable cups retained in the housing of the dispenser.

3. The cup dispenser according to claim 1, adapted to dispense disposable cups of differing size having a brim diameter in the range of from about 65 mm to about 85 mm.

4. The cup dispenser according to claim 3, containing a stack of paper cups each of which is provided with a curled brim.

5. The cup dispenser according to claim 4, wherein said first interchangeable dispensing ring is configured to require an extraction force of from about 0.8 lbs to about 1.4 lbs to remove a paper cup from the stack thereof retained in the housing when the paper cups have a brim diameter of about 70 mm.

6. The cup dispenser according to claim 5, wherein said first interchangeable dispensing ring is configured to require an extraction force of from about 0.9 lbs to about 1.2 lbs to remove a paper cup from the stack thereof retained in the housing when the paper cups have a brim diameter of about 70 mm.

7. The cup dispenser according to claim 5, wherein said first plurality of dispensing tabs define a dispensing diameter of about 66 mm.

8. The cup dispenser according to claim 4, wherein said second interchangeable dispensing ring is configured to require an extraction force of from about 1.4 lbs to about 5 lbs to remove a paper cup from the stack thereof retained in the housing when the paper cups have a brim diameter of about 78 mm.

9. The cup dispenser according to claim 8, wherein said second interchangeable dispensing ring is configured to require an extraction force of from about 2 lbs to about 4 lbs to remove a paper cup from the stack thereof retained in the housing when the paper cups have a brim diameter of about 70 mm.

10. The cup dispenser according to claim 8, wherein said second plurality of dispensing tabs define a dispensing diameter of about 72 mm.

11. The cup dispenser according to claim 1, wherein said first and second interchangeable dispensing rings are integrally formed of a polymeric material.

12. The cup dispenser according to claim 11, wherein said first and second plurality of dispensing tabs are angled downwardly with respect to the plane in which the bases of the tabs are anchored to their respective support rings at an angle of from about 5° to about 25° degrees.

13. The cup dispenser according to claim 11, wherein said first and second interchangeable dispensing rings are injection molded from a polymeric material.

14. The cup dispenser according to claim 13, wherein said polymeric material comprises LDPE.

15. The cup dispenser according to claim 13, wherein said polymeric material comprises HDPE.

16. The cup dispenser according to claim 13, wherein said polymeric material 5 comprises polypropylene.

17. The cup dispenser according to claim 13, wherein said first plurality of tabs consists of four tabs.

18. The cup dispenser according to claim 13, wherein said second plurality of tabs consists of eight tabs.

19. The cup dispenser according to claim 13, wherein said first and second plurality of tabs each have a central portion projecting inwardly to define the dispensing diameter of their respective dispensing rings and lateral passive portions adjacent their central portions which project inwardly a lesser distance than their central portions.

20. The cup dispenser according to claim 19, wherein the central portions of the tabs of at least one of the dispensing rings extend around at least 180° of the periphery of the dispensing aperture of said dispenser.

21. The cup dispenser according to claim 19, wherein the central portion of the tabs of at least one of the dispensing rings extend around less than 180° of the periphery of the dispensing aperture of the dispenser.

22. The cup dispenser according to claim 19, wherein the central portions of said tabs have rounded corners at the edges of their central portions defining the dispensing diameters of their respective dispensing rings.

23. The cup dispenser according to claim 13, wherein said first plurality of tabs and said second plurality of tabs have a thickness of from about 0.5 mm to about 1 mm.

24. The cup dispenser according to claim 1, wherein said first and second dispensing rings are provided with indicia indicating a cup size the respective ring is adapted to dispense.

25. A cup dispenser for dispensing disposable cups of differing size with variable extraction force comprising:
(a) a housing configured to receive a stack of disposable cups, the housing defining a housing opening as well as support means for receiving a dispensing ring member;
(b) a variable extraction force dispensing ring mounted at the housing opening by the support means defining a dispensing aperture configured to retain the stack of cups in the dispenser housing and require a predetermined extraction force to remove a cup from the stack, said variable extraction force dispensing ring comprising a support ring with a first and second plurality of equally spaced dispensing tabs anchored about their bases to an interior surface of the support ring in substantially a single plane, wherein
(i) each of the first plurality of tabs projects inwardly a first predetermined distance,
(ii) each of the second plurality of tabs projects inwardly a second predetermined distance,
said first plurality of dispensing tabs and said second plurality of dispensing tabs being thus configured to require a first predetermined extraction force to remove a cup of a first brim diameter from a stack retained in the housing and to require a second predetermined extraction force to remove a cup of a second brim diameter from a stack retained in the housing.

26. The cup dispenser according to claim 25, wherein the first predetermined extraction force required to remove a cup of a first brim diameter from a stack of disposable cups retained in the housing differs from the second predetermined extraction force required to remove a cup of a second brim diameter from a stack of disposable cups retained in the housing of the dispenser.

27. The cup dispenser according to claim 25, adapted to dispense disposable cups of differing size having a brim diameter in the range of from about 65 mm to about 85 mm.

28. The cup dispenser according to claim 27, containing a stack of paper cups provided with a curled brim.

29. The cup dispenser according to claim 28, wherein said first plurality of tabs of the dispensing ring are configured to require an extraction force of from about 0.8 lbs to about 1.4 lbs to remove a paper cup from the stack thereof retained in the housing when the cups have a brim diameter of about 70 mm.

30. The cup dispenser according to 29, wherein said first plurality of tabs of the dispensing ring are configured to require an extraction force of from about 0.9 lbs to about 1.2 lbs to remove a paper cup from the stack thereof retained in the housing when the cups have a brim diameter of about 70 mm.

31. The cup dispenser according to claim 29, wherein said first plurality of dispensing tabs define a dispensing diameter of about 66 mm.

32. The cup dispenser according to claim 28, wherein the dispensing ring is configured to require an extraction force of from about 1.4 lbs to about 5 lbs to remove a paper cup from the stack thereof retained in the housing when the cups have a brim diameter of about 78 mm.

33. The cup dispenser according to claim 32, wherein the dispensing ring is configured to require an extraction force of from about 2 lbs to about 4 lbs to remove a paper cup from the stack thereof retained in the housing when the cups have a brim diameter of about 78 mm.

34. The cup dispenser according to claim 32, wherein said second plurality of dispensing tabs define a dispensing diameter of about 72 mm.

35. The cup dispenser according to claim 25, wherein said variable extraction force dispensing ring is integrally formed of a polymeric material.

36. The cup dispenser according to claim 35, wherein said first and second plurality of dispensing tabs are angled downwardly with respect to the plane in which the bases of the tabs are anchored to the support ring at an angle of from about 5° to about 25° degrees.

37. The cup dispenser according to claim 35 wherein said dispensing ring is injection molded from a polymeric material.

38. The cup dispenser according to claim 37, wherein said polymeric material comprises LDPE.

39. The cup dispenser according to claim 37, wherein said polymeric material comprises HDPE.

40. The cup dispenser according to claim 37, wherein said polymeric material comprises polypropylene.

41. The cup dispenser according to claim 37, wherein said first plurality of tabs consists of four tabs.

42. The cup dispenser according to claim 37, wherein said second plurality of tabs consists of four tabs.

43. The cup dispenser according to claim 37, wherein said first and second plurality of tabs each have a central portion projecting inwardly to define a dispensing diameter of the dispensing ring and lateral passive portions adjacent their central portions which project inwardly a lesser distance than their central portions.

44. The cup dispenser according to claim 43, wherein the central portions of the tabs of at least one of the first or second plurality of tabs extend around at least 180° of the periphery of the dispensing aperture of said dispenser.

45. The cup dispenser according to claim 43, wherein the central portion of the tabs of at least one of the first or second plurality of tabs extend around less than 180° of the periphery of the dispensing aperture of the dispenser.

46. The cup dispenser according to claim 43, wherein the central portions of said tabs have rounded corners at the edges of their central portions defining the dispensing diameters of the dispensing ring.

47. The cup dispenser according to claim 37, wherein said first plurality of tabs and said second plurality of tabs have a thickness of from about 0.5 mm to about 1 mm.

48. The paper cup dispenser according to 25, wherein said variable extraction force dispensing ring is provided with indicia indicating a cup size range the ring is adapted to dispense.

49. A cup dispenser for dispensing cups of differing size with variable extraction force comprising:
(a) a housing configured to receive a stack of disposable cups, the housing defining a housing opening as well as support means for receiving a dispensing ring member;
(b) means for defining a dispensing aperture at the housing opening comprising at least one dispensing ring mounted on the housing support means therefor, the means for defining the dispensing aperture being generally configured to releasably retain the stack of disposable cups within said housing and require a predetermined extraction force to extract a cup from the stack in the housing, the required predetermined extraction force being variable depending upon the brim diameter of the cup, wherein the means for defining the dispensing aperture is selected from the group consisting of:
(i) a first and a second interchangeable dispensing rings, each of which rings is adapted to be selectively mounted on the support means of the dispenser housing to define a dispensing aperture, and each of which rings is configured to retain the stack of cups in the dispenser housing and require a predetermined extraction force to remove a cup from the stack,
(A) said first interchangeable dispensing ring comprising a first support ring with a first plurality of equally spaced dispensing tabs anchored about their bases to an interior surface of the first support ring in substantially a single plane, wherein each of the first plurality of tabs projects inwardly a first predetermined distance and are thus configured to require a first predetermined extraction force to remove a cup of a first diameter from the stack of disposable cups retained in the housing thereby,
(B) said second interchangeable dispensing ring comprising a second support ring with a second plurality of equally spaced dispensing tabs anchored about their bases to an interior surface of the second support ring in substantially a single plane, wherein each of the second plurality of tabs projects inwardly a second predetermined distance and are thus configured to require a second predetermined extraction force to remove a cup of a second diameter from the stack of disposable cups retained in the housing thereby, and
(ii) a variable extraction force dispensing ring configured to retain the stack of cups in the dispenser housing and require a predetermined extraction force to remove a cup from the stack, said variable extraction force dispensing ring comprising a third support ring with a third and fourth plurality of equally spaced dispensing tabs anchored about their bases to an interior surface of the third support ring in substantially a single plane, wherein
(A) each of the third plurality of tabs projects inwardly a third predetermined distance,
(B) each of the fourth plurality of tabs projects inwardly a fourth predetermined distance,
said third plurality of dispensing tabs and said fourth plurality of dispensing tabs being thus configured to require a first predetermined extraction force to remove a cup of a first brim diameter from a stack retained in the housing and to require a second predetermined extraction force to remove a cup of a second brim diameter from a stack retained in the housing.
